(19) United States
(12) Patent Application Publication
(10) Pub. No.: US 2006/0281660 A1
(43) Pub. Date: Dec. 14, 2006

(54) Liquid compositions having an improved thickening system

(76) Inventors: Brian Xiaoqing Song, Mason, OH (US); Roy Jerome Harrington, Hamilton, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/149,817

(22) Filed: Jun. 10, 2005

(51) Int. Cl. C11D 3/20

(52) U.S. Cl. 510/477

(57) ABSTRACT

Disclosed are liquid compositions, such as liquid detergent compositions, having an improved thickening system. In certain embodiments, this invention relates to liquid automatic dishwashing detergent compositions having an improved thickening system. The thickening system is based on a polyacrylate polymer thickener and an alkali metal silicate having mixed in an alkali metal aluminate with a molar ratio of aluminum metal to SiO2 of less than 0.01:1.

### FIELD OF THE INVENTION

This invention relates to liquid compositions, such as liquid detergent compositions, having an improved thickening system. In certain embodiments, this invention relates to aqueous automatic dishwashing detergent compositions which have a yield value and are shear-thinning, a method of making such compositions, and a composition made by such a method.

### BACKGROUND OF THE INVENTION

Compositions having a thickening system are known and disclosed in U.S. Pat. No. 4,116,851 to Rupe et al, issued Sep. 26, 1978; U.S. Pat. No. 4,431,559 to Ulrich, issued Feb. 14, 1984; U.S. Pat. No. 4,511,487 to Pruhs et al, issued Apr. 16, 1985; U.S. Pat. No. 4,512,908 to Heile, issued Apr. 23, 1985; Canadian Patent 1,031,229, Bush et al; European Patent Application 0130678, Heile, published Jan. 9, 1985; European Patent Application 0176163, Robinson, published Apr. 2, 1986; UK Patent Application 2,116,199A, Julemont et al, published Sep. 21, 1983; UK Patent Application 2,140,450A, Julemont et al, published Nov. 29, 1984; UK Patent Application 2,163,447A, Colarusso, published Feb. 6, 1986; UK Patent Application 2,164,350A, Lai et al, published Mar. 19, 1986; U.K. Patent Application 2,176,495A, Drapler et al, published Dec. 31, 1986; and U.K. Patent Application 2,185,037A, Dixit, published Jul. 8, 1987.

U.S. Pat. No. 2,892,797, Alexander et al, issued Jun. 30, 1959, discloses a process for modifying a silica sol to provide increased stability. This process comprises treatment with a metalate (e.g., sodium aluminate) solution. U.S. Pat. No. 3,255,117, Knapp et al, issued Jun. 7, 1966, discloses automatic dishwashing detergent compositions in granular form containing an amphoteric metal compound, e.g., an aluminate. Similar disclosures are made in U.S. Pat. No. 3,350,318, Green, issued Oct. 31, 1967; U.S. Pat. No. 3,852,209, Hofmann, issued Dec. 3, 1974; U.S. Pat. No. 3,826,748, Finck, issued Jul. 30, 1974; U.S. Pat. No. 2,575,576, Bacon et al, issued Nov. 20, 1951; U.S. Pat. No. 2,514,304, Bacon et al, issued Jul. 4, 1950; and U.S. Pat. No. 2,241,984, Cooper, issued May 13, 1941.

U.S. Pat. No. 3,755,180, Austin, issued Aug. 28, 1973, discloses a composition for use in an automatic dishwasher containing a precipitated silico-aluminate compound. (See also U.S. Pat. No. 3,966,627, Gray, issued Jun. 29, 1976).

U.S. Pat. No. 4,941,988, Wise, issued Jul. 17, 1990, discloses compositions having an optimized thickening system based on an alkali metal silica colloid with dispersed therein an alkali metal aluminate, wherein the molar ratio of aluminum metal to SiO2 is from 0.01:1 to 0.1:1.

It has now been found that a polyacrylate-sodium silicate-sodium aluminate thickening system works even better outside the range of the molar ratio of aluminum metal to SiO2 of from about 0.01:1 to about 0.1:1 disclosed in the Wise patent. That is, it has been found that a molar ratio of aluminum metal to SiO2 of less than 0.01:1, for example, from about 0.001:1 to less than 0.01:1, is superior to thickening systems in which the molar ratio is greater than 0.01:1. A ratio of greater than 0.01:1 may lead to a non-preferred rheology and may also lead to phase separation.

### SUMMARY OF THE INVENTION

This invention relates to liquid compositions, such as liquid detergent compositions, having an improved thickening system. In certain embodiments, this invention relates to aqueous liquid automatic dishwashing detergent compositions which have a yield value and are shear-thinning, a method of making such compositions, and a composition made by such a method. The term “liquid”, as used herein, includes liquids and gels.

The compositions may comprise liquid detergent compositions comprising:

(a) from about 0.25% to about 10%, alternatively, from about 0.25% to about 2%, of a polycarboxylate polymer thickening agent; and

(b) from about 2% to about 20% alternatively, from about 2% or 5% to about 15%, on a solids basis, of the combination of an alkali metal silicate and alkali metal aluminate, wherein the molar ratio of aluminum metal to SiO₂ is from about 0.001:1 to less than 0.01:1, alternatively, from about 0.002:1 to less than 0.01:1;

(c) a chlorine bleach ingredient to yield available chlorine in an amount from 0%, alternatively from about 0.3%, to about 2.5%, alternatively, from about 0.5% to about 1.5%;

(d) optionally a detergent ingredient; and

(e) water.

The composition may have an apparent yield value of from about 40 to about 800 dynes/cm², alternatively, from about 100 to about 600 dynes/cm².

### DETAILED DESCRIPTION OF THE INVENTION

This invention relates to liquid compositions, such as liquid detergent compositions, having an improved thickening system. In certain embodiments, this invention relates to aqueous automatic dishwashing detergent compositions which have a yield value and are shear-thinning, a method of making such compositions, and a composition made by such a method.

The thickening system of the present compositions is based on a polymeric thickener and the combination of an alkali metal silicate and an alkali metal aluminate. The combination of the alkali metal silicate and alkali metal aluminate may form an intermediate, or may exist as a mixture. Although this Detailed Description refers to the combination as a mixture, intermediates formed by the reaction of the alkali metal silicate and alkali metal aluminate are also included herein.

Polymeric Thickener

The thickening agent in the compositions of the present invention is a high molecular weight polycarboxylate polymer thickener. By “high molecular weight” is meant a weight average molecular weight from about 500,000 to about 5,000,000, including from about 750,000 to about 4,000,000. All molecular weights stated throughout this description are weight average molecular weights, unless otherwise stated.

The polycarboxylate polymer may be a carboxyvinyl polymer. Such compounds are disclosed in U.S. Pat. No. 2,798,053, issued on Jul. 2, 1957, to Brown. Methods for making carboxyvinyl polymers are also disclosed in Brown.

A carboxyvinyl polymer is an interpolymer of a monomeric mixture comprising a monomeric olefinically unsaturated carboxylic acid, and from about 0.1% to about 10% by weight of the total monomers of a polyether of a polyhydric alcohol. The polyhydric alcohol contains at least four carbon atoms to which are attached at least three hydroxyl groups, the polyether containing more than one alkenyl group per molecule. Other monoolefinic monomeric materials may be present in the monomeric mixture if desired, even in predominant proportion. Carboxyvinyl polymers are substantially insoluble in liquid, volatile organic hydrocarbons and are dimensionally stable on exposure to air.

Suitable polyhydric alcohols used to produce carboxyvinyl polymers include polyols selected from the class consisting of oligosaccharides, reduced derivatives thereof in which the carbonyl group is converted to an alcohol group, and pentaerythritol. One suitable polyol is sucrose. The hydroxyl groups of the polyol which are modified may be etherified with allyl groups, the polyol having at least two allyl ether groups per polyol molecule. When the polyol is sucrose, the sucrose may have at least about five allyl ether groups per sucrose molecule. The polyether of the polyol may comprise from about 0.1% to about 4% of the total monomers, alternatively from about 0.2% to about 2.5%.

Monomeric olefinically unsaturated carboxylic acids suitable for use in producing the carboxyvinyl polymers used herein include monomeric, polymerizable, alpha-beta monoolefinically unsaturated lower aliphatic carboxylic acids. Suitable monomeric monoolefinic acrylic acids have the structure 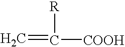
where R is a substituent selected from the group consisting of hydrogen and lower alkyl groups; most preferred is acrylic acid.

Various carboxyvinyl polymers are commercially available from Noveon, Inc. of Cleveland, Ohio, U.S.A., under the trade name CARBOPOL®. These polymers are also known as carbomers or polyacrylic acids. Carboxyvinyl polymers useful in formulations described herein include CARBOPOL® 910 having a molecular weight of about 750,000, CARBOPOL® 941 carboxyvinyl polymers having a molecular weight of about 1,250,000, and CARBOPOL® 934 and 940 carboxyvinyl polymers having molecular weights of about 3,000,000 and 4,000,000, respectively.

CARBOPOL® 934 is a very slightly cross-linked carboxyvinyl polymer having a molecular weight of about 3,000,000. It has been described as a high molecular weight polyacrylic acid cross-linked with about 1% of polyallyl sucrose having an average of about 5.8 allyl groups for each molecule of sucrose.

Additional polycarboxylate polymers useful in the compositions described herein are SOKOLAN PHC-25®, a polyacrylic acid available from BASF Corp. and GANTREZ® a poly(methyl vinyl ether/maleic acid) interpolymer available from GAF Corp., Wayne, N.J., U.S.A., and polyacrylate polymers.

Other polycarboxylate polymers useful in the compositions described herein are non-linear, water-dispersible, polyacrylic acid cross-linked with a polyalkenyl polyether and having a molecular weight of from about 750,000 to about 4,000,000.

Examples of these polycarboxylate polymer thickeners are the CARBOPOL® 600 series resins, including CARBOPOL® 616, 617 and 676 resins. It is believed that these resins are more highly cross-linked than the 900 series resins and have molecular weights between about 1,000,000 and 4,000,000. Mixtures of these polycarboxylate polymers may also be used in the compositions described herein. One suitable mixture is a mixture of CARBOPOL® 616, 617 and 676 series resins.

Other examples of these polycarboxylate polymer thickeners are POLYGEL DK, DV and DKP available from 3V Sigma Corporation. Other examples include FLOGEL 700 available from SNF Floerger, Cedex, France.

The polycarboxylate polymer thickener may be utilized with essentially no clay thickening agents. In other words, the polycarboxylate polymer is alternatively used instead of clay as a thickening/stabilizing agent in the compositions.

The polycarboxylate polymer thickening agent may be present at any suitable level in the compositions including, but not limited to a level of from about 0.25% to about 10%, alternatively from about 0.5% to about 2%.

The polycarboxylate polymer thickening agent may provide an apparent yield value of from about 40 to about 800, or alternatively, from about 100 to about 600, dynes/cm², to the compositions.

The yield value is an indication of the shear stress at which the gel strength is exceeded and flow is initiated. It is measured herein with a Brookfield RVT model viscometer with a T-bar B spindle at 25° C. utilizing a Helipath drive upward during associated readings. The system is set to 0.5 rpm and a torque reading is taken for the composition to be tested after 30 seconds or after the system is stable. The system is stopped and the rpm is reset to 1.0 rpm. A torque reading is taken for the same composition after 30 seconds or after the system is stable.

Apparent viscosities are calculated from the torque readings using factors provided with the Brookfield viscometer. An apparent or Brookfield yield value is then calculated as: Brookfield Yield Value=(apparent viscosity at 0.5 rpm−apparent viscosity at 1 rpm)/100. This is the common method of calculation, published in CARBOPOL® literature and in other published references.

Alkali Metal Silicate:

A second component in the improved thickening system is an alkali metal silicate. Alkali metal silicates, which provide alkalinity and protection of hard surfaces, such as fine china glaze and patterns on fine china, glasses, and other tableware, is generally employed in any suitable amount including, but not limited to amounts ranging from about 2 to about 20 weight percent, alternatively from about 5 to about 15 weight percent. The silicate may be added in the form of an aqueous solution. In one embodiment, the solution may have a SiO₂: Na₂O or SiO₂:K₂O weight ratio of about 1:1 to about 3.6:1, or alternatively from about 2.0:1 to about 2.6:1.

Alkali Metal Aluminate

A third component in the improved thickening systems is aluminum, such as an alkali metal aluminate (e.g., comprising sodium and/or potassium). The alkali metal aluminate may interact with alkali metal silicate to form an intermediate. The combination of the alkali metal silicate and the alkali metal aluminate, or any intermediate formed thereby, then interacts with the polymeric thickener to provides additional structuring to the polymeric thickener, therefore improving the thickening efficiency of the polymeric thickener, permitting less thickener to be used while maintaining the desired rheology profile. This may be used to produce a liquid automatic dishwashing composition at a lower cost. Without wishing to be bound by theory, it is believed that the addition of the alkali metal aluminate to silicate leads to formation of negatively charged colloidal particles which interact with the negative charges of the carboxylate groups on the cross-linked polyacrylate polymer. This increases the negative charge repulsions between the carboxylate groups therefore leading to increased swelling of polymeric thickener particles and increased thickener efficiency. Therefore, this allows for a reduction in the amount of polymer needed.

Other metalates, of amphoteric metals, e.g., zinc, beryllium, cadmium, lead, etc., will act similarly in the compositions, to provide this polymer structuring benefit. These alternative metalates are intended to be covered by the present invention as well. However, the remaining disclosure will focus on the alkali metal aluminates.

The compositions described herein can be made in any suitable manner. The alkali metal aluminate can be added at any point in the process before the polymeric thickener. It was not necessary to premix the alkali metal aluminate with silicate first before adding other detergent ingredients such as builder, alkalinity etc. However, the alkali metal aluminate should be added to the composition being formed, the latter being referred to as the “solution premix”, before mixing the solution premix with the polymer thickener or polymer thickener premix (ie., hydrated polymer particles).

More specifically, a commercial grade of alkali metal aluminate solution can be used directly without the need to make up the solution using powder or granule aluminate. For example, such a 45% solution of sodium aluminate in water is available from USALCO of Baltimore, Md., U.S.A. Such a solution may provide a source of aluminum anions (for example, Na⁺ Al₂⁻ or Na₂⁺ (AlO₂⁻)₂). The aluminate solution can be added to an alkali metal silicate solution to form a combination of an alkali metal silicate and alkali metal aluminate, or the aluminate solution can be added to a solution premix already containing the silicate, builder, pH adjusting ingredients, or other detergent ingredients to form an aluminate/solution premix, and then the aluminate/solution premix can be blended with the polymer thickener to build viscosity. The combination of the alkali metal silicate and the alkali metal aluminate may, but need not form an alkali metal silica colloid having an alkali metal aluminate dispersed therein to form a silico-aluminate colloidal dispersion.

Any suitable amount of alkali metal aluminate can be used. In certain embodiments, less than about, or less than or equal to about 0.2% of a 45% solution of sodium aluminate may allow the amount of thickener to be reduced from about 1.5% to about 1.15% to about 1.2%. This can result in a savings of the more expensive thickener of about 20%.

Any suitable amount of the combination of alkali metal silicate and an alkali metal aluminate can be used. For example, a combination of from about 2% to about 20%, alternatively from about 3% to about 15%, on a solids basis, of the alkali metal silicate and an alkali metal aluminate, wherein the molar ratio of aluminum metal to SiO₂ in the mixture is from about 0.001:1 to less than 0.01:1, alternatively from about 0.002:1 to less than 0.01:1, may be added to the polyacrylate polymer thickener to get the additional structuring.

Detergent Surfactants

The compositions can contain any suitable amount of surfactant(s). For example, the compositions can contain from 0% to about 5%, alternatively from about 0.1% to about 2.5%, of a detergent surfactant.

Desirable detergent surfactants, in general, include nonionic detergent surfactants, anionic detergent surfactants, amphoteric and zwitterionic detergent surfactants. and mixtures thereof.

Examples of nonionic surfactants include:

(1) The condensation product of 1 mole of a saturated or unsaturated, straight or branched chain, alcohol or fatty acid containing from about 10 to about 20 carbon atoms with from about 4 to about 50 moles of ethylene oxide. Specific examples of such compounds include a condensation product of 1 mole of coconut fatty acid or tallow fatty acid with 10 moles of ethylene oxide; the condensation of 1 mole of oleic acid with 9 moles of ethylene oxide; the condensation product of 1 mole of stearic acid with 25 moles of ethylene oxide; the condensation product of 1 mole of tallow fatty alcohols with about 9 moles of ethylene oxide; the condensation product of 1 mole of oleyl alcohol with 10 moles of ethylene oxide; the condensation product of 1 mole of C₁₉ alcohol and 8 moles of ethylene oxide; and the condensation product of one mole of C₁₈ alcohol and 9 moles of ethylene oxide.

The condensation product of a fatty alcohol containing from 17 to 19 carbon atoms, with from about 6 to about 15 moles, alternatively 7 to 12 moles, for example, 9 moles, of ethylene oxide. More particularly, it may be desirable that the fatty alcohol contain 18 carbon atoms and be condensed with from about 7.5 to about 12, alternatively about 9, moles of ethylene oxide. These various specific C₁₇-C₁₉ ethoxylates give extremely good performance even at lower levels (e.g., 2.5%-3%) and at the higher levels (less than 5%) are sufficiently low sudsing, especially when capped with a low molecular weight (C₁₋₅) acid or alcohol moiety, so as to minimize or eliminate the need for a suds-suppressing agent. Suds-suppressing agents in general tend to act as a load on the composition and to hurt long term spotting and filming characteristics.

(2) Polyethylene glycols or polypropylene glycols having molecular weight of from about 1,400 to about 30,000, e.g., 20,000; 9,500; 7,500; 6,000; 4,500; 3,400; and 1,450. All of these materials are wax-like solids which melt between 110° F. and 200° F. (43.3° C. and 93.3° C.).

(3) The condensation products of 1 mole of alkyl phenol wherein the alkyl chain contains from about 8 to about 18 carbon atoms and from about 4 to about 50 moles of ethylene oxide. Specific examples of these nonionics are the condensation products of 1 mole of decylphenol with 40 moles of ethylene oxide; the condensation product of 1 mole of dodecyl phenol with 35 moles of ethylene oxide; the condensation product of mole of tetradecylphenol with 25 moles of ethylene oxide; the condensation product of 1 mole of hectadecylphenol with 30 moles of ethylene oxide, etc.

(4) Polyoxypropylene, polyoxyethylene condensates having the formula HO(C₂H₄O)ₓ(C₃H₆O)_{y}(C₂H₄O)ₓH or HO(C₃H₆O)_{y}(C₂H₄O)ₓ(C₃H₆O)_{y} H where total y equals at least 15 and total (C₂H₄O) equals 20% to 90% of the total weight of the compound and the molecular weight is from about 2,000 to about 10,000, alternatively from about 3,000 to about 6,000. These materials are, for example, the PLURONIC®s from BASF, which are well known in the art.

(5) The compounds of (1) which are capped with propylene oxide, butylene oxide and/or short chain alcohols and/or short chain fatty acids, e.g., those containing from 1 to about 5 carbon atoms, and mixtures thereof.

Useful surfactants in detergent compositions are those having the formula RO—(C₂H₄O)ₓR¹ wherein R is an alkyl or alkylene group containing from 17 to 19 carbon atoms, x is a number from about 6 to about 15, alternatively from about 7 to about 12, and R¹ is selected from the group consisting of: hydrogen, C₁₋₅ alkyl groups, C₂₋₅ acyl groups and groups having the formula —(C_{y}H_{2y}O)ₙ H wherein y is 3 or 4 and n is a number from one to about 4.

Some suitable surfactants are the low-sudsing compounds of (4), the other compounds of (5), and the C₁₇₋₁₉ materials of (1) which have a narrow ethoxy distribution.

In addition to the above mentioned surfactants, other suitable surfactants for detergent compositions can be found in the disclosures of U.S. Pat. Nos. 3,544,473, 3,630,923, 3,888,781 and 4,001,132.

Some of the aforementioned surfactants are bleach-stable but some are not. When the composition contains a hypochlorite bleach it may be desirable that the detergent surfactant be bleach-stable. Such surfactants desirably do not contain functions such as unsaturation and some aromatic, amide, aldehydic, methyl keto or hydroxyl groups which are susceptible to oxidation by the hypochlorite.

Bleach-stable anionic surfactants which are especially resistant to hypochlorite oxidation fall into two main groups. One such class of bleach-stable anionic surfactants are the water-soluble alkyl sulfates and/or sulfonates, containing from about 8 to 18 carbon atoms in the alkyl group. Alkyl sulfates are the water-soluble salts of sulfated fatty alcohols. They are produced from natural or synthetic fatty alcohols containing from about 8 to 18 carbon atoms. Examples of such surfactants are available from BASF Corp sold under the trade names of AVANEL® such as AVANEL® S74. Natural fatty alcohols include those produced by reducing the glycerides of naturally occuring fats and oils. Fatty alcohols can be produced synthetically, for example, by the Oxo process. Examples of suitable alcohols which can be employed in alkyl sulfate manufacture include decyl, lauryl, myristyl, palmityl and stearyl alcohols and the mixtures of fatty alcohols derived by reducing the glycerides of tallow and coconut oil.

Specific examples of alkyl sulfate salts which can be employed in the instant detergent compositions include sodium lauryl alkyl sulfate, sodium stearyl alkyl sulfate, sodium palmityl alkyl sulfate, sodium decyl sulfate, sodium myristyl alkyl sulfate, potassium lauryl alkyl sulfate, potassium stearyl alkyl sulfate, potassium decyl sulfate, potassium palmityl alkyl sulfate, potassium myristyl alkyl sulfate, sodium dodecyl sulfate, potassium dodecyl sulfate, potassium tallow alkyl sulfate, sodium tallow alkyl sulfate, sodium coconut alkyl sulfate, magnesium coconut alkyl sulfate, calcium coconut alkyl sulfate, potassium coconut alkyl sulfate and mixtures of these surfactants. Highly preferred alkyl sulfates are sodium coconut alkyl sulfate, potassium coconut alkyl sulfate, potassium lauryl alkyl sulfate and sodium lauryl alkyl sulfate.

A second class of bleach-stable surfactant materials are the water-soluble betaine surfactants. These materials have the general formula: 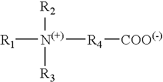
wherein R₁ is an alkyl group containing from about 8 to 18 carbon atoms; R₂ and R₃ are each lower alkyl groups containing from about 1 to 4 carbon atoms, and R₄ is an alkylene group selected from the group consisting of methylene, propylene, butylene and pentylene. (Propionate betaines decompose in aqueous solution and hence may not be included in the instant compositions).

Examples of suitable betaine compounds of this type include dodecyldimethylammonium acetate, tetradecyldimethylammonium acetate, hexadecyldimethylammonium acetate, alkyldimethylammonium acetate wherein the alkyl group averages about 14.8 carbon atoms in length, dodecyldimethylammonium butanoate, tetradecyldimethylammonium butanoate, hexadecyldimethylammonium butanoate, dodecyldimethylammonium hexanoate, hexadecyldimethylammonium hexanoate, tetradecyldiethylammonium pentanotate and tetradecyldipropyl ammonium pentanoate. Especially preferred betaine surfactants include dodecyldimethylammonium acetate, dodecyldimethylammonium hexanoate, hexadecyldimethylammonium acetate, and hexadecyldimethylammonium hexanoate.

Nonionic surfactants useful herein include ethoxylated and/or propoxylated nonionic surfactants such as those available from BASF Corp. of New Jersey. Examples of such compounds are polyethylene oxide, polypropylene oxide block copolymers sold under the trade names PLURONIC® and TETRONIC® available from BASF Corp.

Useful members of this class are capped oxyalkylene oxide block copolymer surfactants of the following structure: 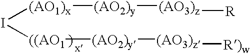
where I is the residue of a monohydroxyl, dihydroxyl, or a polyhydroxyl compound; AO₁, AO₂, and AO₃ are oxyalkyl groups and one of AO₁ and AO₂ is propylene oxide with the corresponding x or y being greater than zero, and the other of AO₁ and AO₂ is ethylene oxide with the corresponding x or y being greater than zero, and the molar ratio of propylene oxide to ethylene oxide is from about 2:1 to about 8:1; R and R′ are hydrogen, alkyl, aryl, alkyl aryl, aryl alkyl, carbamate, or butylene oxide; w is equal to zero or one; and z, x′, y′, and z′ are greater than or equal to zero.

Other bleach-stable surfactants include amine oxides, phosphine oxides, and sulfoxides. However, such surfactants are usually high sudsing. A disclosure of bleach-stable surfactants can be found in published British Patent Application 2,116,199A; U.S. Pat. No. 4,005,027, Hartman; U.S. Pat. No. 4,116,851, Rupe et al; U.S. Pat. No. 3,985,668, Hartman; U.S. Pat. No. 4,271,030, Brierley et al; and U.S. Pat. No. 4,116,849, Leikhim.

Other desirable bleach-stable surfactants are the alkyl phosphonates, taught in U.S. Pat. No. 4,105,573, to Jacobsen, issued Aug. 8, 1978.

Still other bleach-stable anionic surfactants include the linear or branched alkali metal mono- and/or di-(C₈₋₁₄) alkyl diphenyl oxide mono- and/or disulphonates, commercially available under the trade names DOWFAX 3B-2 (sodium n-decyl diphenyloxide disulfonate) and DOWFAX 2A-1. These and similar surfactants are disclosed in published U.K. Patent Applications 2,163,447A; 2,163,448A; and 2,164,350A.

Bleaching Agent

The compositions optionally include a bleaching agent which yields a hypochlorite species in aqueous solution. The hypochlorite ion is chemically represented by the formula OCl⁻. The hypochlorite ion is a strong oxidizing agent, and for this reason materials which yield this species are considered to be powerful bleaching agents.

The strength of an aqueous solution containing hypochlorite ion is measured in terms of available chlorine. This is the oxidizing power of the solution measured by the ability of the solution to liberate iodine from an acidified iodide solution. One hypochlorite ion has the oxidizing power of 2 atoms of chlorine, i.e., one molecule of chlorine gas.

At lower pH levels, aqueous solutions formed by dissolving hypochlorite-yielding compounds contain active chlorine, partially in the form of hypochlorous acid moieties and partially in the form of hypochlorite ions. At pH levels above about 10, essentially all of the active chlorine is in the form of hypochlorite ion.

Those bleaching agents which yield a hypochlorite species in aqueous solution include alkali metal and alkali earth metal hypochlorites, hypochlorite addition products, chloramines, chlorimines, chloramides, and chlorimides. Specific examples of compounds of this type include sodium hypochlorite, potassium hypochlorite, monobasic calcium hypochlorite, dibasic magnesium hypochlorite, chlorinated trisodium phosphate dodecahydrate, potassium dichloroisocyanurate, sodium dichloroisocyanurate, sodium dichloroisocyanurate dihydrate, trichlorocyanuric acid, 1,3-dichloro-5,5-dimethylhydantoin, N-chlorosulfamide, Chloramine T, Dichloramine T, Chloramine B and Dichloramine B. One suitable bleaching agent for use in the compositions of the instant invention is sodium hypochlorite.

Most of the above-described hypochlorite-yielding bleaching agents are available in solid or concentrated form and are dissolved in water during preparation of the compositions of the instant invention. Some of the above materials are available as aqueous solutions.

If present, the above-described bleaching agents may be dissolved in the aqueous liquid component of the present composition. Bleaching agents can provide from 0%, alternatively from about 0.3%, to 2.5% available chlorine by weight, alternatively from about 0.5% to about 1.5% available chlorine, by weight of the total composition.

Buffering Agent

In the instant compositions, it may be desirable to also include one or more buffering agents capable of maintaining the pH of the compositions within the alkalinity range for performance and stability of the composition.

When a hypochlorite bleach is optionally included in the instant compositions, maintenance of the composition pH within the 10 to 12 range, when measured in a 1% aqueous solution, minimizes undesirable chemical decomposition of the active chlorine, hypochlorite-yielding bleaching agents. Decomposition may be encountered when such bleaching agents are admixed with clay in unbuffered aqueous solution. Maintenance of this particular pH range also minimizes the chemical interaction between the strong hypochlorite bleach and the surfactant compounds present in the instant compositions. Finally, as noted, high pH values such as those maintained by an optional buffering agent serve to enhance the soil and stain removal properties during utilization of the present compositions.

Any compatible material or mixture of materials which has the effect of maintaining the composition pH within the alkalinity pH range, for example, within the 10 to 12 range, can be utilized as the buffering agent. Such materials can include, for example, hydroxides and various water-soluble, inorganic salts such as the carbonates, bicarbonates, sesquicarbonates, silicates, pyrophosphates, phosphates, tetraborates, and mixtures thereof. Examples of materials which can be used either alone or in combination as the buffering agent herein include sodium carbonate, sodium bicarbonate, potassium carbonate, sodium sesquicarbonate, sodium silicate, potassium silicate, sodium pyrophosphate, tetrapotassium pyrophosphate, tripotassium phosphate, trisodium phosphate, anhydrous sodium tetraborate, sodium tetraborate pentahydrate, potassium hydroxide, sodium hydroxide, and sodium tetraborate decahydrate. Combination of these buffering agents, which include both the sodium and potassium salts, may be used. If present, the above-described buffering agent materials are dissolved or suspended in the aqueous liquid component. Buffering agents, if present, can comprise any suitable amount of the composition, such as from about 2% to 20% by weight, alternatively from about 5% to 15% by weight, of the total composition.

Detergency Builder

Detergency builders are desirable materials which reduce the free calcium and/or magnesium ion concentration in a aqueous solution. However, low builder or nil-builder (especially phosphate builder) detergents are becoming more important because of environmental reasons. They may be used herein in any suitable amount including, but not limited to at a level of from about 0% to about 30%, alternatively from about 0% to about 20%. The detergency builder may be sodium tripolyphosphate in an amount from about 2% to about 25%, alternatively from about 5% to about 20%. Generally, a certain percentage of the sodium tripolyphosphate is in an undissolved particulate form suspended in the rest of the detergent composition. A phosphate ester, if present in the composition, works to keep such solid particles suspended in the aqueous solution.

The detergency builder material can be any of the detergent builder materials known in the art which include trisodium phosphate, tetrasodium pyrophosphate, sodium tripolyphosphate, sodium hexametaphosphate, potassium pyrophosphate, potassium tripolyphosphate, potassium hexametaphosphate, sodium silicates having SiO₂:Na₂ 0 weight ratios of from about 1:1 to about 3.6:1, sodium carbonate, sodium hydroxide, sodium citrate, borax, sodium ethylenediaminetetraacetate, sodium nitrilotriacetate, sodium carboxymethyloxysuccinate, sodium carboxymethyloxymalonate, polyphosphonates, salts of low molecular weight carboxylic acids, and polycarboxylates, polymeric carboxylates such as polyacrylates, and mixtures thereof.

Some of the above-described buffering agent materials additionally serve as builders. It may be desirable for the buffering agent to contain at least one compound capable of additionally acting as a builder.

Other Optional Materials

The compositions may optionally comprise zinc compounds. In particular, it may be desirable for the zinc compounds to comprise particulate zinc-containing materials (PZCMs).

Particulate zinc-containing materials (PZCMs) remain mostly insoluble within formulated compositions. Examples of PZCMs useful in certain non-limiting embodiments may include the following:

Inorganic Materials: zinc aluminate, zinc carbonate, zinc oxide and materials containing zinc oxide (i.e., calamine), zinc phosphates (i.e., orthophosphate and pyrophosphate), zinc selenide, zinc sulfide, zinc silicates (i.e., ortho- and meta-zinc silicates), zinc silicofluoride, zinc borate, zinc hydroxide and hydroxy sulfate, zinc-containing layered materials, and combinations thereof.

Natural Zinc-containing Materials/Ores and Minerals: hydrozincite, sphalerite (zinc blende), wurtzite, smithsonite, franklinite, zincite, willemite, troostite, hemimorphite, and combinations thereof.

Organic Salts: zinc fatty acid salts (i.e., caproate, laurate, oleate, stearate, etc.), zinc salts of alkyl sulfonic acids, zinc naphthenate, zinc tartrate, zinc tannate, zinc phytate, zinc monoglycerolate, zinc allantoinate, zinc urate, zinc amino acid salts (i.e., methionate, phenylalinate, tryptophanate, cysteinate, etc), and combinations thereof.

Polymeric Salts: zinc polycarboxylates (i.e., polyacrylate), zinc polysulfate, and combinations thereof.

Physically Adsorbed Forms: zinc-loaded ion exchange resins, zinc adsorbed on particle surfaces, composite particles in which zinc salts are incorporated (i.e., as core/shell or aggregate morphologies), and combinations thereof.

Zinc Salts: zinc oxalate, zinc tannate, zinc tartrate, zinc citrate, zinc oxide, zinc carbonate, zinc hydroxide, zinc oleate, zinc phosphate, zinc silicate, zinc stearate, zinc sulfide, zinc undecylate, and the like, and combinations thereof.

Commercially available sources of zinc oxide include Z-COTE™ and Z-COTE HPI™ (BASF), and USP I and USP II (Zinc Corporation of America).

Zinc-containing layered materials (ZCLMs) are a subclass of PZCMs. Layered structures are those with crystal growth primarily occurring in two dimensions. It is conventional to describe layer structures as not only those in which all the atoms are incorporated in well-defined layers, but also those in which there are ions or molecules between the layers, called gallery ions (A. F. Wells “Structural Inorganic Chemistry”, Clarendon Press, 1975). For example, ZCLMs may have Zn²⁺ ions incorporated in the layers and/or as more labile components of the gallery ions.

Many ZCLMs occur naturally as minerals. Common examples include hydrozincite (zinc carbonate hydroxide), basic zinc carbonate, aurichalcite (zinc copper carbonate hydroxide), rosasite (copper zinc carbonate hydroxide) and many related minerals that are zinc-containing. Natural ZCLMs can also occur wherein anionic layer species such as clay-type minerals (e.g., phyllosilicates) contain ion-exchanged zinc gallery ions. Other suitable ZCLMs include the following: zinc hydroxide acetate, zinc hydroxide chloride, zinc hydroxide lauryl sulfate, zinc hydroxide nitrate, zinc hydroxide sulfate, hydroxy double salts, and mixtures thereof. Natural ZCLMs can also be obtained synthetically or formed in situ in a composition or during a production process.

Hydroxy double salts can be represented by the general formula:
[M²⁺₁₋ₓM²⁺₁₊ₓ(OH)_{3(1-y)}]⁺Aⁿ⁻_{(1=3y)/n}.nH₂O
where the two metal ions may be different; if they are the same and represented by zinc, the formula simplifies to [Zn₁₊ₓ(OH)₂]^{2x+}2x A⁻.nH₂O (see Morioka, H., Tagaya, H., Karasu, M, Kadokawa, J, Chiba, K Inorg. Chem. 1999, 38, 4211-6). This latter formula represents (where x=0.4) common materials such as zinc hydroxychloride and zinc hydroxynitrate. These are related to hydrozincite as well, when a divalent anion replaces the monovalent anion.

Commercially available sources of zinc carbonate include zinc carbonate basic (Cater Chemicals: Bensenville, Ill., USA), zinc carbonate (Shepherd Chemicals: Norwood, Ohio, USA), zinc carbonate (CPS Union Corp.: New York, N.Y., USA), zinc carbonate (Elementis Pigments: Durham, UK), and zinc carbonate AC (Bruggemann Chemical: Newtown Square, Pa., USA).

Conventional coloring agents and perfumes can also be added to the compositions to enhance their aesthetic appeal and/or consumer acceptability. These materials should, of course, be those dye and perfume varieties which are especially stable against degradation by high pH and/or strong active chlorine bleaching agents if such bleaching agents are also present.

If present, the above-described other optional materials generally may comprise no more than about 10% by weight of the total composition and are dissolved, suspended, or emulsified in the present compositions.

Exemplary Compositions

One category of embodiments of the compositions is a liquid automatic dishwashing composition which is essentially a single-phase clear gel. This is achieved by making a minimum molar substitution of 45-60% of the sodium ions typically present in such compositions with potassium ions. This solubilizes builder and electrolyte anions. Such a composition may be thickened with a polymeric thickener such as a polyacrylate instead of a clay thickener, since the latter would opacify the formula. Such compositions may provide advantages with respect to physical shelf stability, dissolution rate, dispersing fluidity, and retention of product in the package versus formulas which contain suspended salt solids. The sodium ions present in solution generally come from the sodium tripolyphosphate, sodium carbonate, sodium silicate, and sodium hydroxide. The molar substitution of alkalinity metal cations can be achieved by substituting therefor tetra potassium polyphosphate, potassium hydroxide, potassium carbonate, potassium bicarbonate, or potassium silicate.

Examples of the compositions are liquid automatic dishwasher detergent compositions comprising:
(a) from about 0% to about 18% of sodium tripolyphosphate;
(b) hypochlorite bleach in an amount to provide from about 0.5% to about 1.5% of available chlorine to the composition;
(c) from about 0% to about 2.5% of a bleach-stable surfactant;
(d) from 0.1 to about 5% of alkali metal hydroxide;
(e) from about 0.5% to about 1.5% of a polyacrylic polymer having a molecular weight greater than 750,000; and
(f) from about 2% to about 20%, on a solids basis, of an alkali metal silicate and alkali metal aluminate mixture wherein the molar ratio of aluminum metal to SiO₂ is from about 0.001:1 to less than 0.01:1;
   said liquid detergent may contain no clay suspending agents and having an apparent yield value of from about 100 to about 600 dynes/cm².
   Method of Preparation

The compositions may be prepared in any suitable manner. In one non-limiting embodiment, the method of making a liquid detergent composition comprises:

(a) forming a solution premix comprising an alkali metal silicate, a chlorine bleach ingredient, water, and optionally at least one detergent ingredient;

(b) providing an alkali metal aluminate solution;

(c) mixing the solution premix with the alkali metal aluminate solution to form an aluminate/solution premix;

(d) providing a polycarboxylate polymer premix made by hydrating a polycarboxylate polymer thickening agent in water; and

(e) mixing the polycarboxylate polymer premix with the aluminate/solution premix to form the liquid detergent composition.

Other suitable processes that can be modified to produce such compositions are described in U.S. Pat. No. 4,941,988, issue to Wise, and U.S. Pat. No. 5,510,047 issued to Gabriel, et al. with the modification of adding an alkali metal aluminate solution to the “solution premix” before blending with the “polymer premix”.

### EXAMPLES

The following non-limiting Examples are provided to illustrate the invention and facilitate its understanding.

Formulas 1-5 are examples of liquid automatic dishwashing compositions of the present invention. Formula 6 is a comparative example.

| Formula parts | | | | | | |
|---|---|---|---|---|---|---|
| (% active) | Formula 1 | Formula 2 | Formula 3 | Formula 4 | Formula 5 | Formula 6 |
| STPP (sodium | 15 | 15 | 15 | 7 | 7 | 7 |
| tripolyphosphate) | | | | | | |
| Sodium citrate | 0 | 0 | 0 | 0 | 10 | 0 |
| Sodium silicate solids | 20 | 15 | 10 | 12 | 12 | 12 |
| (2.0 ratio) | | | | | | |
| Sodium or potassium | 1.5 | 1.5 | 1.5 | 1.5 | 1.5 | 1.5 |
| hydroxide | | | | | | |
| AvCl from sodium | 1.0 | 1.0 | 1.0 | 0.9 | 0.9 | 0.9 |
| hypochlorite | | | | | | |
| Zinc compounds | 0 | 0.12 | 0.12 | 0 | 0.12 | 0.12 |
| (PZCMs) | | | | | | |
| Cross-linked | 0.6 | 0.8 | 0.8 | 1.2 | 0.8 | 1.2 |
| polyacrylic acid | | | | | | |
| thickener | | | | | | |
| Sodium aluminate | 0.04 | 0.06 | 0.06 | 0.05 | 0.08 | 0.20 |
| Perfume, dye, water | Balance | Balance | Balance | Balance | Balance | Balance |
| Molar ratio of Al to | 0.002 | 0.0044 | 0.0066 | 0.0046 | 0.0074 | 0.018 |
| SiO2 | | | | | | |
| Rheology/phase | gel/ | gel/ | gel/ | gel/ | gel/ | Coagulated/ |
| stability | stable | stable | stable | stable | stable | phase |
| | | | | | | separation |

As used throughout this specification, all percentages, parts, and ratios are by weight unless otherwise stated.

The level of sodium aluminate (NaAlO₂ or Na₂Al₂O₄), containing 32.9% Al, may be varied in the composition to deliver up to 0.1% Al. The commercial sodium aluminate contains 30-45% solids in water solution. The solution can be added to the batch containing aqueous silicate in the process to form a silicate-aluminate mixture. Other ingredients such as STPP, sodium citrate, hydroxide can then be added to the mixture to form a “solution premix”. Alternatively, the sodium aluminate solution can be added to the batch already containing other ingredients such as STPP, sodium citrate, hydroxide. Silicate solution can then be added to the batch to form a “solution premix”. The solution premix is then mixed with a 5% polyacrylate polymer premix to form a gel base. If the composition also contains chlorine, preferably the chlorine bleach is added next to the gel base. The resultant composition is a thixotropic gel with an apparent yield value of about 100-600 dynes/cm².

Homogeneity of the sample is improved by allowing for residual swelling of the neutralized polyacrylate for one day, prior to rheological measurements.

Samples containing aluminate are visibly thicker than those without. The aluminate appears to be increasing polymer interaction. As additive level of aluminate increases, eg., to 0.2% (formula 6), which increases the molar ratio of aluminum to SiO2 about 0.01:1, sample smoothness begins to decrease. At higher levels of aluminate, the samples show signs of coagulation, graininess, or curdling, and the Theological thickening begins to reverse as the maximum benefit levels of aluminate are surpassed. In addition, the composition may separate into distinct phases with a clear water layer on top of the coagulated gel.

The disclosure of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present invention. To the extent that any meaning or definition of a term in this written document conflicts with any meaning or definition of the term in a document incorporated by reference, the meaning or definition assigned to the term in this document shall govern.

It should be understood that every maximum numerical limitation given throughout this specification would include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

While particular embodiments of the subject invention have been described, it will be obvious to those skilled in the art that various changes and modifications of the subject invention can be made without departing from the spirit and scope of the invention. It will be clear to those skilled in the art that various changes and modifications may be made without departing from the scope of the invention and the invention is not to be considered limited to the embodiments and examples that are described in the specification.

What is claimed is:

1. A liquid detergent composition comprising:
(a) from about 0.25% to about 2.0% of a polycarboxylate polymer thickening agent having a molecular weight greater than about 500,000; and
(b) from about 2% to about 20%, on a solids basis, of the combination of an alkali metal silicate and an alkali metal aluminate, wherein the molar ratio of aluminum metal to SiO₂ is from about 0.001:1 to less than 0.01:1;
(c) a chlorine bleach ingredient to provide from 0% to about 2.5% of available chlorine based on the weight of the detergent composition;
(d) optionally a detergent ingredient; and
(e) water.

2. A composition according to claim 1 having an apparent yield value of from about 40 to about 800 dynes/cm².

3. The composition of claim 1 wherein the polycarboxylate polymer thickening agent is a polyacrylate thickener having a molecular weight greater than 750,000.

4. The composition of claim 1 wherein the combination of the silicate and aluminate comprises from about 5% to about 15%, on a solids basis, of the composition.

5. The composition of claim 1 wherein the molar ratio of aluminum metal to SiO₂ is from about 0.002:1 to less than 0.01:1.

6. The composition of claim 1 wherein the chlorine bleach ingredient is hypochlorite bleach.

7. The composition of claim 1 wherein said other detergent ingredient comprises a zinc compound.

8. The composition of claim 7 wherein said zinc compound comprises particulate zinc-containing materials (PZCMs).

9. The composition of claim 1 wherein said detergent ingredient comprises a detergent surfactant, and the detergent surfactant is selected from the group consisting of C₈-C₁₈ alkyl sulfates, C₈-C₁₈ alkyl sulfonates, and mixtures thereof.

10. The composition of claim 1 wherein said detergent ingredient comprises a detergency builder, and the detergency builder material is selected from the group consisting of sodium tripolyphosphate, sodium carbonate, potassium pyrophosphate, potassium carbonate, sodium pyrophosphate, sodium citrate, sodium ethylenediaminetetraacetate, sodium nitrilotriacetate, sodium carboxymethyloxysuccinate, sodium carboxymethyloxymalonate, polyphosphonates, salts of low molecular weight carboxylic acids, and polycarboxylates, polymeric carboxylates such as polyacrylates, and mixtures thereof.

11. A liquid automatic dishwashing detergent composition comprising:
(a) from about 0.5% to about 2% of a polycarboxylate polymer thickening agent having a molecular weight greater than about 750,000; and
(b) from about 2% to about 15%, on a solids basis, of the combination of an alkali metal silicate and an alkali metal aluminate, wherein the molar ratio of aluminum metal to SiO₂ is from about 0.002:1 to less than 0.01:1;
(c) a chlorine bleach ingredient to provide from 0.5% to about 1.5% of available chlorine based on the weight of the detergent composition;
(d) optionally a detergent ingredient; and
(e) water,
said composition having an apparent yield value of from about 100 to about 600 dynes/cm².

12. A liquid detergent composition comprising:
(a) from about 0.25% to about 2.0% of a polycarboxylate polymer thickening agent having a molecular weight greater than about 500,000; and
(b) from about 2% to about 20%, on a solids basis, of the combination of an alkali metal silicate and an aluminum compound, wherein the molar ratio of aluminum metal to SiO₂ is from about 0.001:1 to less than 0.01:1;
(c) a chlorine bleach ingredient to provide from 0% to about 2.5% of available chlorine based on the weight of the detergent composition;
(d) optionally a detergent ingredient; and
(e) water.

13. A method of making a liquid detergent composition comprising:
(a) providing an alkali metal silicate solution;
(b) providing an alkali metal aluminate solution;
(c) providing optionally at least one detergent ingredient;
(d) mixing said alkali metal silicate, alkali metal aluminate and optionally an detergent ingredient, in any order, to form a solution premix;
(e) providing a polycarboxylate polymer premix made by hydrating a polycarboxylate polymer thickening agent in water; and
(f) mixing said polycarboxylate polymer premix with said solution premix to form said liquid detergent composition.

14. The method of claim 13 wherein said at least one detergent ingredient comprises one or more of the following: a detergency builder, a chlorine bleach, and a pH adjusting ingredient.

15. The method of claim 14 wherein the amount of said chlorine bleach ingredient is sufficient to provide from 0% to about 2.5% of available chlorine based on the weight of the detergent composition.

16. The method of claim 13 wherein said solution premix comprises from about 2% to about 20%, on a solids basis, of the combination of an alkali metal silicate and an alkali metal aluminate, wherein the molar ratio of aluminum metal to SiO₂ is from about 0.001:1 to less than 0.01:1.

17. A liquid detergent composition made by the method of claim 13.

18. A method of making a liquid detergent composition comprising:
(a) providing an alkali metal aluminate solution;
(b) providing an alkali metal silicate solution;
(c) mixing said alkali metal silicate with said alkali metal aluminate solution to form an alkali metal silicate-aluminate premix, wherein premix comprises from about 2% to about 20% of said composition, on a solids basis, and the molar ratio of aluminum metal to SiO₂ is from about 0.001:1 to less than 0.01:1;
(d) providing at least one detergent ingredient;
(e) mixing said alkali metal silicate-aluminate premix and said at least one detergent ingredient to form a detergent premix;
(f) providing a polycarboxylate polymer premix comprising a polycarboxylate polymer thickening agent hydrated in water; and
(g) mixing said polycarboxylate polymer premix with said detergent premix to form said liquid detergent composition.
